(19) United States
(12) Patent Application Publication
(10) Pub. No.: US 2023/0375092 A1
(43) Pub. Date: Nov. 23, 2023

(54) AN IMPROVED THERMO PLASTIC BALL VALVE ASSEMBLY

(71) Applicant: ASTRAL LIMITED, Bodakdev, Ahmedabad (IN)

(72) Inventor: Sandeep Pravinbhai ENGINEER, Ahmedabad (IN)

(21) Appl. No.: 18/044,710

(22) PCT Filed: Aug. 13, 2021
(86) PCT No.: PCT/IN2021/050778

§ 371 Date: Mar. 9, 2023

(30) Foreign Application Priority Data
Sep. 9, 2020 (IN) 202021038928

(51) Int. Cl. F16K 5/06; F16K 31/60

(52) U.S. Cl. CPC F16K 5/0647; F16K 31/60

(57) ABSTRACT

The present invention relates to an improved thermoplastic ball valve assembly which comprises a handle or leverage, a stem, a ball, an end plug, a PTFE (Teflon) seat, a valve body, an O ring of the end plug and an O ring of the stem. The improved thermoplastic ball provided with the two O ring grooves in the stem and PTFE seat is provided on the both side of the ball on the groove of the body for eliminating the leakage and smooth operation of the valve. The socket of the valve body having more length so that better joining of pipe in socket can be done and eliminating sticking issues of solvent cement on ball. The present invention is easy to be installed, reliable to be sealed, easy to operate and strong in practicability.

### CROSS-REFERENCE TO RELATED APPLICATIONS

This application claims the benefit of International Application No. PCT/IN2021/050778, filed on Aug. 13, 2021, which claims the benefit of Indian Patent Application 20201038928, filed on Sep. 9, 2020. The entire disclosures of the above applications are incorporated herein by reference.

### FIELD OF INVENTION

The present technology relates to a valve art and, more particularly, it relates to an improved thermo plastic ball valve assembly.

### BACKGROUND OF INVENTION

In today's world industrial sector becomes growing sector and existing industries become improve his technologies day to day. In the industries different types of fluid are used such as hot water. The fluids are passes through the pipes and this type of fluids needed to control as per requirement using the valves. The valve control is easy technique to control the flow of fluid.

The valve controls the flow of the fluid as per requirement of user. There are many types of fluid valves available in the market which control fluid in which the ball valve is also used in the industrial, commercial, agriculture and residential use. The ball type valve is easy to operate and almost all type of fluid and slurry can be handled. The ball valve in the pipeline is mainly used to cut off or distribute a media flow, or to change the direction of a media flow. Due to its compact structure, reliable sealing, easy operation and maintenance, the ball valve is comprehensively applied in various fields.

Thermo plastic ball valves are known shutoff armatures widely and increasingly used and applied in different applications. Thermo plastic ball valves can be operated at a comparatively lower torque of operation/actuation and at the same time, they have a maximum free cross section of flow in their open status of operation.

While valve constructions of conventional type are known in the art, the specific constructions and operational details thereof have not satisfactorily met the needs of industry. In particular, some prior designs have involved very sophisticated and/or cumbersome structures which cause production difficulties and add to the valve costs in conventional type of thermo plastic ball valve. Further, a common disadvantage of all prior art thermo plastic ball valve designs is that they have an issue of sticking of the solvent cement on ball due to less socket length in body and in end plug. Due to such design, the leakage due to PTFE seats in longer operation is observed. Further, in existing state of art, the stem O ring grooves are formed through the direct injection moulding technique which may affects the performance of the valve at long term use. Further in conventional valve, the PTFE rings are directly seated on both side of ball. In such case, there are chances of leakage through PTFE side. Further, during assembling of end-plug to body, the end-plug is cross fitted or slip out because of there is no stopper/guide on end plug.

U.S. Pat. No. 3,540,693A provide a random-entry cartridge type ball valve assembly including a pair of flanged connecting members, and a tubular valve body positioned between the flanged members and secured thereto by a plurality of nut and bolt connections. A valve bail member is rotatably mounted within the valve body and pluralities of annular sealing assemblies are provided within the valve body between the ball member and the flanged connecting members. Each of the sealing assemblies comprises an outer annular retainer and an inner annular seal in engagement with the ball member. A recess is provided between the valve body and each of the connecting members for the purpose of enabling the flanges on the connecting members to be placed under compression by the nut and bolt assemblies to thereby compress the annular seals between the ball member and the flanges to provide an adequate seal between the ball member and the connecting members.

The limitation of the prior art is it does not provide the smooth operation and there is no any PTFE rings are provided so it may be occurrence of leakage of fluid. Further it has possibility of the occurrence of the cross connection or slip-out of the valve to the pipe.

It has, therefore, been desired to develop a Thermo plastic ball valve which obviates or mitigates aforementioned disadvantages.

### OBJECT OF INVENTION

A main object of the present invention is to provide improved thermo plastic ball valve assembly which is deemed to meet all of the foregoing needs and others.

Another object of present invention is to provide an improved thermo plastic ball valve that gives more safety to the solvent cement joints (in case of PVC/CPVC and ABS) and solve the issue of sticking of the solvent cement on ball.

Further object of the present invention is to provide an improved thermo plastic ball valve wherein the leakage due to PTFE seats is greatly reduced with the new feature of the seating position of the PTFE gaskets.

Yet another object of the present invention is to provide an improved thermo plastic ball valve wherein the stem O ring grooves are machined rather than direct injection moulding which will give superior performance against long term use of the valve.

Another object of the present invention is to provide an improved thermo plastic ball valve which provides easy fitting of end plug of body to the pipe.

Another object of the present invention is to provide an improved thermo plastic ball valve which eliminates the problem of cross fitting or the slip-out of the valve from the pipe.

Another objective of the present invention is to provide an improved thermo plastic ball valve which is smooth to operate and cost effective.

### SUMMARY OF INVENTION

The present invention relates to an improved thermo plastic ball valve assembly which comprises a handle or leverage, a stem, a ball, an end plug, a PTFE (Teflon) seat, a body, an O ring of end plug and an O ring of stem. The improved thermo plastic ball provided with the two O ring grooves in the stem and PTFE seat is provided on the both side of the ball on the groove of the body for eliminating the leakage and smooth operation of the valve. The socket of the body of the valve having more length so that better joining of pipe in socket can be done and eliminating sticking issues of solvent cement on ball. The present invention is easy to be installed, reliable to be sealed, and strong in practicability.

### BRIEF DESCRIPTION OF DRAWINGS

Other objects, advantages and novel features of the invention will become apparent from the following detailed description of the present embodiment when taken in conjunction with the accompanying drawings.

FIG. 1 shows a sectional view of thermo plastic ball valve.

FIG. 2 shows a front view and prospective view of stem of the thermo plastic ball valve.

FIG. 3 shows a sectional view and prospective view PTFE seat of thermo plastic ball valve.

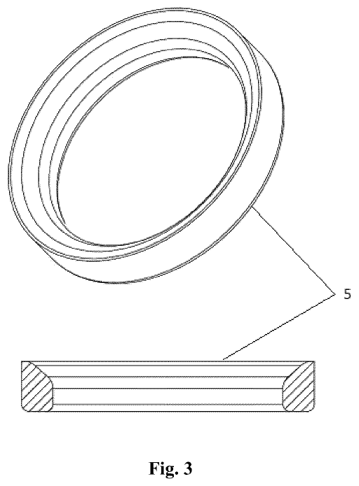

FIG. 4 shows an exploded view and assembly of thermo plastic ball valve.

### BRIEF DESCRIPTION OF INVENTION

Before explaining the present invention in detail, it is to be understood that the invention is not limited in its application to the details of the construction and arrangement of parts illustrated in the accompany drawings. The invention is capable of other embodiment, as depicted in different figures as described above and of being practiced or carried out in a variety of ways. It is to be understood that the phraseology and terminology employed herein is for the purpose of description and not of limitation.

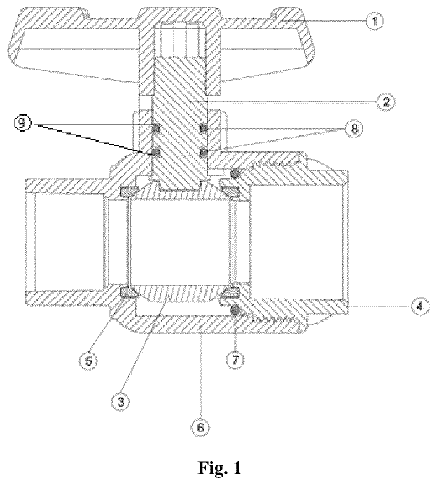

Now, the FIG. 1 shows the sectional view of the improved thermo plastic ball valve according to present invention. The improved thermo plastic ball valve assembly according to present invention comprises a valve body (6) having a flow channel passing through the inside of the valve body (6), a ball (3) having through passage therein, handle or leverage (1), a stem (2), an end plug (4) being detachably connected with the valve body (6), a PTFE (Teflon) seats (5), an O ring of end plug (7), an O ring of stem (8).

The ball (3) is rotatably located in the flow channel of the valve body (6) in which an open condition which permits fluid flow through the flow channel and a closed condition which prevents fluid flow through the flow channel. When the thermo plastic ball valve assembly is open, the ball (3) at the open position, the through passage of the ball (3) is coaxial with the flow channel of the valve body (6), and when the plastic ball valve assembly is closed, the ball (3) at the closed position, the through passage of the ball (3) is perpendicular to the flow channel of the valve body (6). The one end of the valve stem (2) engaged with the handle (1) of the valve, and the other end of the valve stem (2) is connected with the ball (3) for rotating the ball (3).

Referring continuous with FIG. 1, the handle (1) is adapted to switch the ball (3) between the open position and the closed position. The handle (1) is installed on top end of the steam so as rotate the valve stem (2), to rotate the ball (3). The handle (1) having an upper part that is flat on two different levels and on a lower one there is a number of engravings: manufacturer trade mark, open/close marking and size. The lower part has inclined side wall until the tangency with the external diameter of the cylinder which hosts the stem (2). At the end of this cylinder there are two stops that limit the 90 degrees rotation for the opening and closing of the valve.

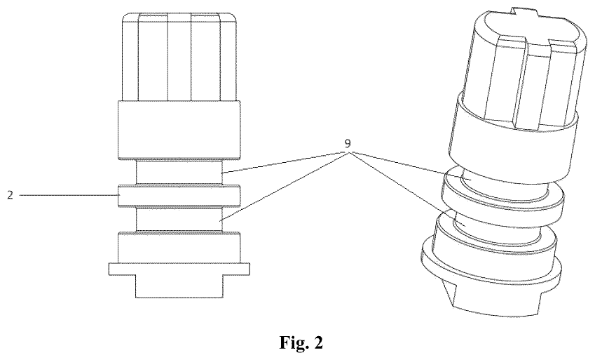

FIG. 2 shows the front view and prospective view of stem (2) of the improved thermo plastic ball valve according to present invention. The stem (2) having two parallel flat areas: the lower one is engaged with the ball (3) and transmits the rotation to the ball (3) and the upper one of stem (2) is to couple with the handle (1). On the external profile of the stem (2) there are two grooves (9) for O-rings (8), the said grooves (9) of stem (2) are obtained by the CNC machine after the moulding. By using process of CNC machine to obtain a grooves (9) of stem (2) eliminate parting line in the stem (2). The O ring of stem (8) is confirmed within each groove (9). This reduces the wear and tear of the O-ring of stem (8) which is placed in said grooves (9) of stem (2). The stem (2) preferably made from the thermo plastic material. The O-rings of stem (8) are preferably made from the rubber and two number of O-rings of stem (8) are provided in two grooves (9) of stem (2) as shown in FIGS. 1 and 2 to ensure water tightness, leak proof operation and smooth operation of the valve.

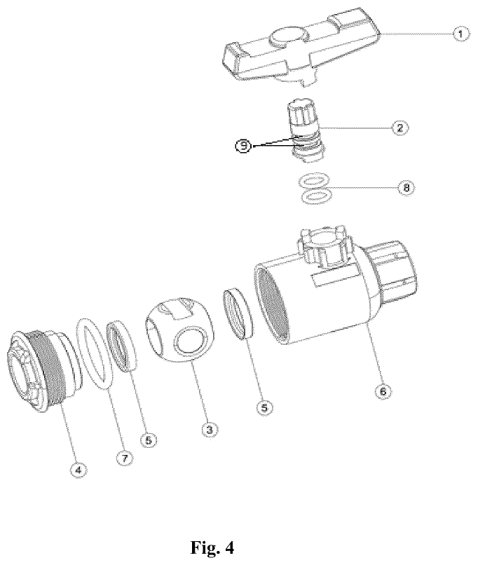

FIG. 1 and FIG. 4 shows the sectional view and prospective view of ball (3) of the improved thermo plastic ball valve assembly. The upper part of the ball (3) portion is slotted in which the flat portion of the stem (2) of the lower part is engaged. The ball (3) is preferably made from the thermo plastic material. The ball (3) can be as-moulded or lathe machined after moulding. The PTFE (Teflon) seats (gaskets) (5) are positioned on the two openings of the through passage of the ball (3) as shown in FIG. 4.

Referring continues to FIG. 1 and FIG. 4 which show the sectional view and exploded view of the improved thermo plastic ball valve assembly. The valve body (6) has two different ends along the axis (which is also the flow direction of the transported fluid). One end is provided with a spigot or a socket which is used for jointing by solvent cementing of pipes according to standard ASTM D2846 SDR11 & ASTM D2467 SCH80 or any other suitable pipe/fitting manufacturing standards and the other end is configured to allow to screw in the end plug (4) after the insertion of the stem (2), and the PTFE (Teflon) gasket (5). Perpendicular to the axis there is a pierced cylinder, inside which the stem (2) is inserted, while on the outside there are longitudinal ribs, parallel two by two, in opposed pairs so that the handle locking device can be kept captive when open or closed.

On the valve body (6) outside diameter there are two flat areas on which are engraved the manufacturer trade mark, the size, the material type, the reference standard and the production calendar. The valve body (6) preferably made from thermo plastic material.

The end plug (4) having spigot or socket utilised for jointing by means of solvent cementing with pipes conform to standard ASTM D2846 SDR11 & ASTM D2467 SCH80 or any other pipe manufacturing standards while on the outside it has a male thread which allows to screw it into the body (6) and groove are provided between the end plug (4) and body (6) for inserting an O-ring of end plug (7) which ensures the tightness and leak proof operation. The end plug (4) has improved seat groove for PTFE (Teflon) seat (5), which arrest PTFE (Teflon) seat (5) from both outside and inside. The end plug also provide circular rib in case of ½″ to 1″ below PTFE (Teflon) seat (5) and provision of providing O-ring (7) below PTFE (Teflon) (5) from 1¼″ to 2″ which provide extra cushioning during open/close function. The PTFE (Teflon) seat (5) is sited on O ring (7) to avoid leakage from the PFTE (Teflon) seat (5) side. In the valve body (6) design, the length of socket or spigot in the both part is increased, as a result batter jointing of pipe and socket using solvent cement and eliminating issues regarding solvent cement sticking in between ball (3) and PTFE (Teflon) seat (5) while assembling.

The PTFE (Teflon) seat (5) is made out of PTFE (poly tetra fluoro ethylene) material which is provided to the both side of the ball (3) on the groove of the body (6) to prevent the leakage in the flow direction.

At the end plug (4) of the valve body (6), the stopper or guide is provided which prevent the valve from the cross fitting or slip out during the assembly. The improved ball Valve having cavity no. engraved on each part i.e. valve body (6), ball (3), stem (2), end plug (4) and handle (1).

The improved thermo plastic ball valve body mould size ½″ to 2″ produced ion fully automatic mode. Due to the fully automatic mode process parameters are stable/uniform from shot to shot and product quality is improved & and defects on product were minimize like burn mark, flow mark etc.

The performance of ball valve by pressure testing has been conducted in the fully automatic mode. In this the automatic pressure testing equipment from low pressure 0.5 bar to high pressure 7.0 bar for 15 minutes conducted and verified by visually for any leakages observed during prescribed duration.

The invention has been explained in relation to specific embodiment. It is inferred that the foregoing description is only illustrative of the present invention and it is not intended that the invention be limited or restrictive thereto. Many other specific embodiments of the present invention will be apparent to one skilled in the art from the foregoing disclosure. All substitution, alterations and modification of the present invention which come within the scope of the following claims are to which the present invention is readily susceptible without departing from the spirit of the invention. The scope of the invention should therefore be determined not with reference to the above description but should be determined with reference to appended claims along with full scope of equivalents to which such claims are entitled.

### REFERENCE NUMERALS

1. Handle
2. Stem
3. Ball
4. End plug
5. PTFE (Teflon) Seat
6. Body
7. O-ring of End plug
8. O-ring of stem
9. Grooves of stem

1-10. (canceled)

11. An improved thermoplastic ball valve assembly comprising:
a valve body having a flow channel passing through an inside of the valve body, a ball having through passage therein, handle or leverage, a stem, an end plug being detachably connected with the valve body, a PTFE (Teflon) seat, an O-ring of the end plug, an O-ring of the stem;
the stem having two parallel flat areas wherein a lower one of the flat areas is engaged with the ball and transmit a rotation to the ball, an upper one of the flat areas is coupled with the handle and an external profile of the stem having two grooves for O-rings; each groove receives an O-ring;
characterized in that,
wherein the body one end provided with a spigot or a socket for jointing by solvent cementing of pipes according to standard ASTM D2846 SDR11 & ASTM D2467 SCH80 or any other suitable pipe/fitting manufacturing standards, and other end configured to allow to screw in the end plug.

12. The improved thermoplastic ball valve assembly of claim 11, wherein the handle having an upper part that is flat on two different levels and on a lower one there is a number of engravings: manufacturer trademark, open/close marking and size.

13. The improved thermoplastic ball valve assembly of claim 11, wherein the O-rings of stem and O-ring of end plug are preferably made from a rubber material.

14. The improved thermoplastic ball valve assembly of claim 11, wherein an upper part of the balls having slot in which the lower one of the flat areas of the stem is engaged.

15. The improved thermoplastic ball valve assembly of claim 11, wherein the PTFE (Teflon) seat is provided to both sides of the ball on the groove of the body.

16. The improved thermoplastic ball valve assembly of claim 11, wherein the O-ring of end plug is provided between the spigot of the valve body and end plug and PTFE (Teflon) seat is sited on the said O-ring of the end plug.

17. The improved thermoplastic ball valve assembly of claim 11, wherein the the grooves for O-rings in stem are obtained by a CNC machine after moulding.

18. The improved thermoplastic ball valve assembly of claim 11, wherein a length of socket or spigot of the valve body in both parts are increased.

19. The improved thermoplastic ball valve assembly of claim 11, wherein the handle, the stem, the valve body, end plug and the ball are made from thermoplastic materials.
